(19) United States
(12) Patent Application Publication
(10) Pub. No.: US 2007/0271579 A1
(43) Pub. Date: Nov. 22, 2007

(54) PLACE BASED MEDIA AND ADVERTISING DISPLAY

(75) Inventors: James H. Harris, Glencoe, IL (US); Robert E. Lee, Waxhaw, NC (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: OFFICE MEDIA NETWORK, INC., Chicago, IL (US)

(21) Appl. No.: 11/748,557

(22) Filed: May 15, 2007

Related U.S. Application Data
(60) Provisional application No. 60/801,893, filed on May 19, 2006.

(51) Int. Cl. H04N 7/10; H04N 7/173; H04N 7/025

(52) U.S. Cl. 725/34; 725/110; 725/35; 725/112

(57) ABSTRACT

An advertising system using digital media collects information from a plurality of sources, automatically processes the information based on set of predetermined criteria, and provides processed information to a plurality of information and advertising display devices. The advertising system allows the information feed provided to each of the display devices to be customized based on a rule set so that the information displayed on each section of a particular display device is customized according to predetermined criteria. The advertising system also allows a user of a particular display device to provide local information that to be displayed in a section of that particular display device.

This is a non-provisional of U.S. Provisional Application Ser. No. 60/801,893, filed May 19, 2006, the entire disclosure of which is incorporated herein by reference.

### BACKGROUND

With the growth of digital media over the last decades an average person is inundated with abundance of information from a very large number of information sources. For example, an average person has access to information from the newspapers, the television medium, from the Internet, etc. However, none of these information sources are accessible to a person during majority of his or her daily activities. Moreover, none of these sources combine ease of access to the information with the timeliness of the information.

For example, a newspaper may be used to receive information while commuting, however, it does not provide up-to-date information. On the other hand a web site on the Internet may be used to receive latest news and other information, however, it is not useful unless a user has access to an Internet browsing device such as a computer, an Internet ready telephone, etc. Moreover, even using the Internet, a user cannot access latest headline news on a number of different issues on a timely basis without having to access a number of different websites. Thus there is a need for a medium that may provide up to date information to users on a variety of issues.

On the other hand, an advertiser who is trying to reach a selected audience simultaneously, wherein the audience is selected based on a predetermined criteria such as the location of the audience, general profession of the audience, other commonality between the members of the audience, etc., may not be able to do so using traditional media such as newspapers, the Internet, etc. Thus, there is a need to provide a medium for providing information to users where the medium may be used by advertisers to reach an audience of a desired demographic.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

An advertising system using digital media collects real-time information from a plurality of sources, automatically processes the information based on set of predetermined criteria, and provides processed information to a plurality of information and advertising display devices. The advertising system allows the real-time information feed provided to each of the display devices to be customized based on a rule set so that the information displayed on each section of a particular display device is customized according to predetermined criteria.

The display devices of the system disclosed in here may be installed in public places such as an airport waiting area, a train stations a lobby of an office building, etc. An alternate embodiment of the advertising system disclosed in here allows a user of a particular display device to alter the predetermined criteria using a secured access web site. The advertising system also allows a user of a particular display device to provide local information that to be displayed in a section of that particular display device.

In yet another embodiment, the display devices are further adapted to receive input from users, such as viewers of the information, from advertises, etc., and to communicate the input provided by the users to an entity providing the information content, an advertiser, etc.

### BRIEF DESCRIPTION OF DRAWINGS

The present patent is illustrated by way of examples and not limitations in the accompanying figures, in which like references indicate similar elements, and in which:

FIG. 1 illustrates an example block diagram of a network interconnecting a plurality of computing resources;

FIG. 2 illustrates an example block diagram of a computer that may be connected to the network of FIG. 1;

FIG. 3 illustrates an example block diagram of an advertising system described in here;

FIG. 4 illustrates an example flowchart of an information display program used by the advertising system described in FIG. 3;

FIG. 5 illustrates an example flowchart of a data processing program used by the information display program of FIG. 4; and

FIG. 6 illustrates an example screen shot of the content displayed on a display device used by the advertising system of FIG. 3.

### DETAILED DESCRIPTION

Although the following text sets forth a detailed description of numerous different embodiments, it should be understood that the legal scope of the description is defined by the words of the claims set forth at the end of this patent. The detailed description is to be construed as an example only and does not describe every possible embodiment since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

### Network

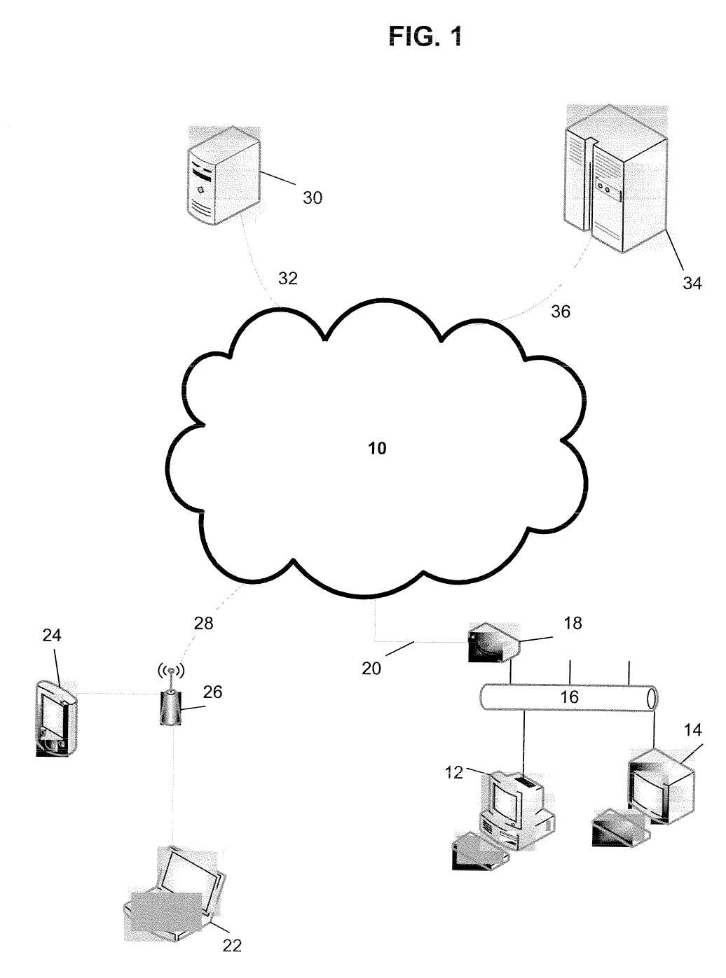

FIG. 1 illustrates a network 10 that may be used to implement a display system described herein. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. As it will be described below in further detail, one or more components of the display system may be stored and operated on any of the various devices connected to the network 10. For example, the display system described in here may store a set of predetermined criteria used to generate requests to a plurality of information sources on the memory of the mainframe 34 while a rule set for controlling certain section of display devices may be stored on the personal computer 12 connected to a display device.

### Computer

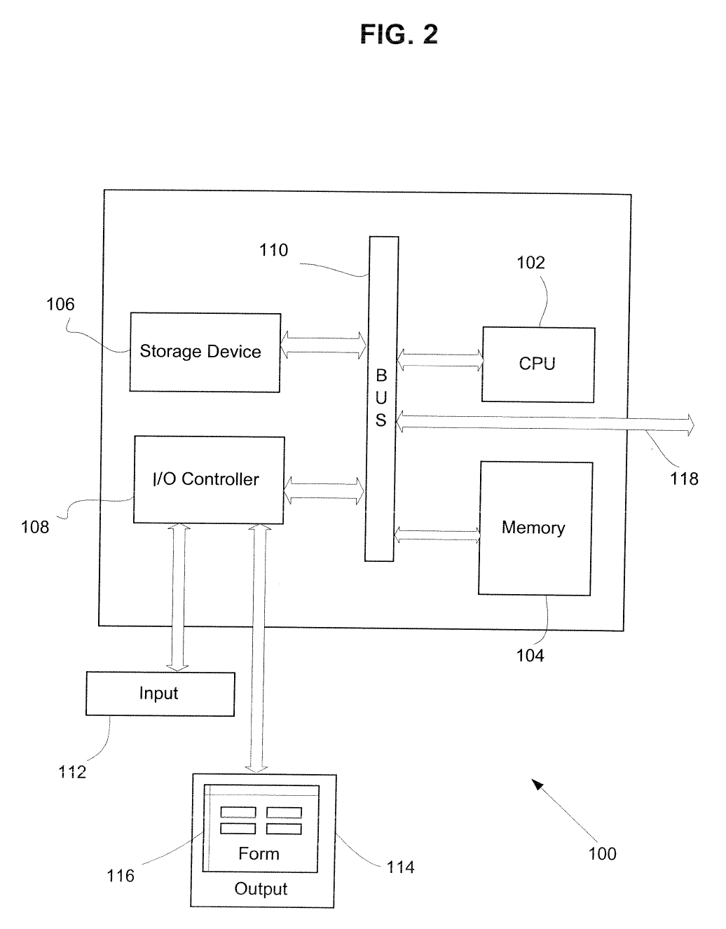

FIG. 2 illustrates a computing device in the form of a computer 100 that may be connected to the network 10 and used to implement one or more components of a display system described herein. Components of the computer 100 may include, but are not limited to a central processing unit (CPU) 102, a memory 104, a storage device 106, an input/output controller 108, and a system bus 110 that couples various system components including the memory to the CPU 102. The system bus 110 may be any of several types of bus structures including a memory bus or memory controller, a peripheral bus, and a local bus using any of a variety of bus architectures.

The memory 104 may include computer storage media in the form of volatile and/or nonvolatile memory such as read only memory (ROM) and random access memory (RAM). A basic input/output system (BIOS), containing the basic routines that help to transfer information between elements within computer 110, such as during start-up, is typically stored in ROM. RAM typically contains data and/or program modules that are immediately accessible to and/or presently being operated on by processing unit 120. The memory 104 may also be used to store data related to one or more programs codes used by the computer 100 and/or the display system.

The storage device 106 may typically include removable/non-removable, volatile/nonvolatile computer storage media. By way of example only, the storage device 106 may include a hard disk drive, a magnetic disk drive, nonvolatile magnetic disk 152, an optical disk drive, etc. One or more of the forms stored on the memory 104 may be populated using data stored on the storage device 106. The 100 controller may be used by the computer 100 to communicate with an input device 112, which may be a keyboard, a mouse, etc., an output device 114, which may be a monitor, a printer, etc.

### Place Based Media and Advertising Display System

The advertising system disclosed in here uses digital media to collect information from a plurality of sources, automatically processes the information based on set of predetermined criteria, and provides processed information to a plurality of information and/or advertising display devices. The advertising system allows the information feed provided to each of the display devices to be customized based on a rule set so that the information displayed on each section of a particular display device is customized according to predetermined criteria. The advertising system also allows a user of a particular display device to provide local information that to be displayed in a section of that particular display device.

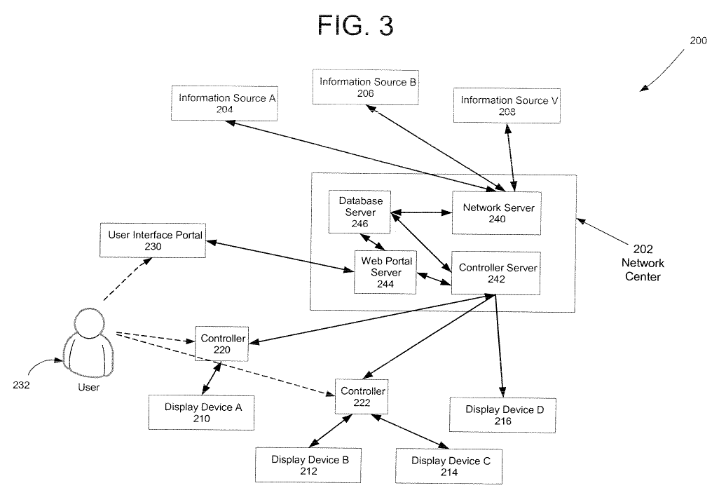

Now turning to the embodiments of the advertising system disclosed in here, FIG. 3 illustrates an example block diagram of an advertising system 200. The advertising system 200 may be used to provide information and advertising to a plurality of display devices, where such display devices may be located in public locations such as airports, railway stations, office buildings, elevators, etc. The advertising system 200 includes a network center 202 that is communicatively connected to information sources 204, 206 and 208. The network center 202 may also be communicatively connected to a number of display devices 210-216. The communication connection between the network center 202 and the display devices 210-216 may be direct as in the case of display device 216, or it may be indirect through controllers. For example a controller 220 may be used to facilitate communication between the network center 202 and the display device 210, while a controller 222 may be used to facilitate communication between the network center 202 and the display devices 212-214. Further more, the advertising system 200 also includes a user interface portal 230 that may be used by a plurality of users 232 to communicate with the network center.

The network center 202 may be connected to the information sources 204-208, the controllers 220-222, the display devices 210-216, and the user interface portal 230 via a number of well known communication structures. For example, the network 10 may be used to connect the various components of the advertising system 200. Thus, in a particular embodiment, the components of the advertising system 200 may be connected via the Internet. Alternatively, there may be a direct communication link, a virtual private network (VPN) link, etc., between the components of the advertising system.

The network center 202 may be a single server residing on a network, such as the network 10. Alternatively, the network center 202 may be a collection of servers, including an SQL™ server for data collection, a communication server to manage communication with the other components of the advertising system 200, a processing server to process information collected from each of the information sources 204-208, etc. No matter in what form the network center 202 is implemented, it may include a processor, a memory, an input/output port, a communication bus, and other similar components, such as those described with respect to computer 100. A user may input information into the memory of the network center using the user interface portal 230, an input device, such as a keyboard connected to the network center 202, etc.

For example, in the illustrated example, the network center 202 includes a network server 240, a controller server 242, a web portal server 244 and a database server 246. The network server 240 may be used to communicate with the information sources 204-208. For example, the network server 240 may run a number of queries based on a set of predetermined criteria stored in the memory of the network center 202. The controller server 232 may be used to connect to each of the controllers 216, etc. The controller server may store a set of predetermined criteria that may be used to send information to the controllers 220-222, or it may receive such criteria from a user via the web server portal 234. The web server portal 234 may be used to communicate with user interface portal 230 to receive information from various users, such as managers of buildings where any of the display devices 210-216 are located.

The database server 222 may be used to various information such as, results of queries to the information sources 204-208, the queries provided by users via the user interface portal 230, the data filed to be communicated to the display devices 210-216, etc. For example, memory of the database server 222 may store a number of predetermined criteria that may be used to process the information received from the information sources 204-208. For example, the network center 202 may store a table of predetermined criteria, with each field providing to a criterion for processing information to be sent to a particular display device. For example, display device 210 may require only weather and financial data whereas the display device 212 may require weather, financial and news data. Alternatively, the network center 202 may also store a table wherein each field provides a criterion as to how often a data file sent to a particular device is to be updated.

In yet another embodiment, the database server 222 may also store a table wherein each field provides a criterion as to at what time intervals the network center 202 should send a request to the information sources 204-208. Note that while the network server 230 is designed to send requests for data to the information sources 204-208, in an alternate embodiment, the advertising system 200 may be set up so that the information sources 204-208 may automatically generate and send data packets to the network center 202 at a predetermined time interval.

Additionally, memory of the network center 202 may also store a program to convert the information received from the information sources 204-208 into an alternate form so that such information may be communicated to the display devices 210-216. For example, in an implementation of the display advertising system where an information source provides information to the network center 202 in XML format, the network center 202 may parse the XML file and convert them into separate data files such as a news data file, a weather information data file, a traffic information data file, etc. In an alternate implementation, an information source may provide information to the network center 202 in any of the HTML format, RSS format, or any other data formats that may be used to exchange data over communication networks. The controller server 232 may communicate such data files to various display devices 210-216.

Moreover, the network center 202 may also store a number of programs to process the information received from the information sources 204-208 so that the information displayed on the display devices 210-216 is appropriate for its individual location, user demographic, etc. Thus, a program stored in the memory of the network center 202 may parse a weather data file received from a national weather information source such that display device 210 displays the local weather condition only. Similarly, if the network center 202 is given information regarding a national advertising campaign by one of the information sources 204-208, with a number of advertises to be distributed to each of the display devices 210-218 based on the demographic of the users of such display devices, a program stored on the network center 202 may allocate an appropriate advertise to an appropriate display device.

The information sources 204-208 may be provided by affiliates of an entity managing the network center 202, or by other third party information providers. For example, the information source 204 may be a weather information service database, the information source 206 may be a stock price database, etc. The information sources 204-208 may be implemented as web servers that support web sites connected to those particular web servers. For example, the information source 204 may be a web server of Dow Jones™ Company that may support the web site of Wall Street Journal™ online. Alternatively, one or more of the information sources 204-208 may also be implemented using an SQL™ server, or other well known database server.

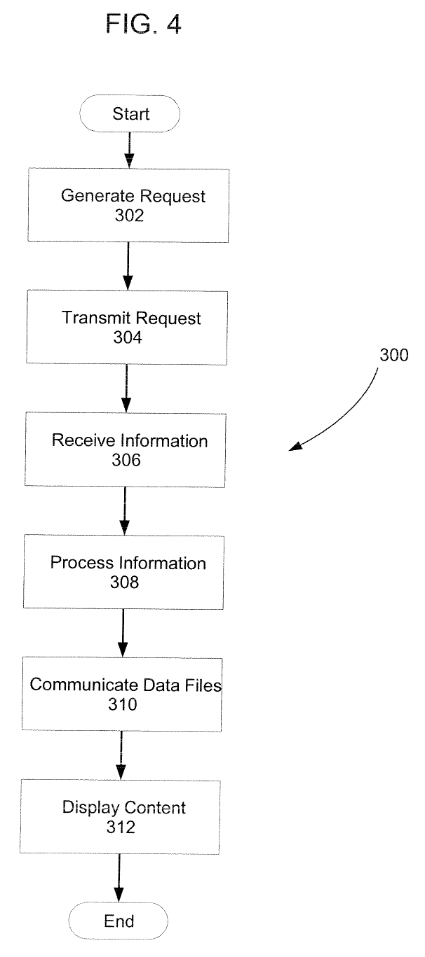

The display devices 210-216 may be located at locations where it gets high visibility from a large number of people. For example, a display device may be located in the lobby of a high rise building where it may be viewed by a number of professionals. Alternatively, a display device may be located in the waiting area of an airport, parking garage, a train station, an elevator, etc. Yet alternatively, a display device may also be located in a restaurant, a coffee-shop etc. A display device may be located on a pedestal designed specifically for the display device or it may be suspended from ceiling or a wall using appropriate structure. An example of a pedestal 250 that may be used for locating a display device is illustrated in FIG. 4.

The controllers 220-222 may be implemented by any well known computing device such as the computer 100. The controllers 220-222 may also be stand alone computing devices separate from the display devices, or they may be implemented as part of the display devices, in which case such a controller may be communicatively connected with a remote input/output device. Moreover, as shown in the advertising system 200, one controller may be supporting a number of display devices. Thus for example, for a number of display devices located at different levels in a high rise building, a single controller may be used to control all of such display devices.

Users 232 may also communicate with one or more of the controllers 220-222 via an input device such as a keyboard, a wireless communication device, etc. For example, when the display devices are located in a high rise building, a building manager may use such an input device to input information related to the building that will be displayed on the display device. In an embodiment, the user may also input instructions that will be displayed on the display device only in special circumstances, such as an emergency, holidays, etc. In an embodiment of the advertising system 200, a display device may also include a speaker to make special announcements. In such a case, the speaker device may be used to announce instructions to people in case of an emergency.

In an alternate embodiment of the advertising system, users 232 may communicate with the controllers 220-222 using the user interface portal 230. In such an implementation, a user of display device 210 may log into the user interface portal 230, at which point that user may be able to monitor and/or change the settings, content, etc., of the display device 210. As discussed below with respect to FIG. 4, a particular section of the screen on the display device may be reserved for displaying local information. In such a case, a user may log into the user interface portal 230 to input such local information that will be displayed on that particular section of the display.

FIG. 4 illustrates an example flowchart of a display program 300 used by the advertising system 200 described in FIG. 3. Various components of the display program 300 may be implemented on a memory of the network center 202. However, as one of ordinary skill in the art would know, components of the display program 300 may be implemented on different platforms where each of such platforms is communicatively connected to the network center 202.

Now referring to the given implementation of the display program 300, a block 302 generates requests for content to one or more of the information sources 204-208. Such content requests may be generated based on the predetermined criteria stored in the memory of the network center 202. For example, a criterion stored in the memory of the network center 202 may specify the frequency at which such data requests are to be generated. Such frequency may be specified separately for each of the information sources. Thus, for example, the content requests for stock prices may be generated every five minutes, while the content requests for weather data may be generated only every hour or so.

Moreover, a criterion stored on the memory of the network center 202 may also provide more detailed specification for content from an information source. For example, a criterion may specify a standard industrial classification (SIC) code for the stock price data to be provided by an information server. Such criteria may be specified by a user using the user interface portal 230. Thus, for example, a user of a display device located in an office building having a large concentration of transportation companies may request stock prices for transportation industry companies to be displayed on the display device.

Subsequently, a block 304 transmits the content request to the information sources 204-108. While in the exemplary implementation of the display program 300, the content requests are transmitted at every specified interval, in an alternate embodiment, a content request may be sent to an information source along with a specified frequency at which such content it to be sent to the network center 202. I such a case, the information source may store the specified frequency locally on the information source server and automatically generate content information at the specified frequency to be sent to the network center 202.

Depending on the format of the content on the information source, the content file transmitted to the network center 202 may be an XML file, a text file, an FTP file, etc. For example, when an information source is a web server, it may generate an XML file to be transmitted to the network center 202. A block 306 receives such content files from information sources and stores them on the memory of the network center 202.

Subsequently, a block 308 processes the content received from the information sources. The processing of the information may depend on the format of the content received, the format in which the data is to be communicated to the display devices, one or more predetermined criteria stored on the memory of the network center 202, etc. For example, if the content received is in XML files, the network center 202 may parse such XML files to extract the content from the XML files. If the data received is in the form of a response to an SQL query, the network center 202 may populate one or more tables in a database on the network center 202.

Moreover, the network center 202 may also further process the content to create data files such as a weather data file, a news data file, etc. Some of these files may be generic for each of the display devices, while some of these data files may be specific for a particular display device. For example, a national news files may be generic for all display devices, whereas a traffic data file for a given city may be specific for display devices located in that given city only.

In an implementation of the advertising system 200, one or more sections of the screens on the display devices 210-216 may be used for content provided by the users 232 via the user interface portal 230. In such cases, the network center 202 may also generate data files using the content input from the user interface portals.

A feed engine may be used to assist in parsing the data files. The feed engine may be part of the control server 242 (FIG. 2) or may be distributed across the various controllers 220, 222. The feed engine may perform a variety of functions. In general, the feed engine attempts to identify the audience of the display and actively determines content to be displayed that is related to the identified audience.

There may be a variety of manners to identify an audience. At a high level, the tenants in a particular building may be known. Further, the general working hours of the tenants may be known. As the general working time of specific tenants may be known, content may be displayed that is relevant to the specific tenants at the time the tenants are working. For example, if a roadway engineering firm has employees that normally work 7:00 am to 3:00 pm, stories may be displayed around 7:00 am and 3:00 pm (when the roadway engineers arrive and leave the building and view the display) that relate to roadway engineering. In addition, say a software company is in the same building and the software engineers work from 11 am to 7 pm. Accordingly, content may be actively displayed that is related to software engineers around 11 am and 7 pm (when the software engineers arrive and leave the building and view the displays).

At a lower level, the feed engine may be even more active. In some buildings, passes or swipe cards are used to restrict access. In order to access parts of the building, the user must use the pass as a form of identification which may be validated by a computer system. For example, a building may have doors that are locked. A valid user may swipe an id near the locked door. The swipe pad may communicate to a validation node that a certain swipe card is being used to try to access a locked door. If the user is acceptable or approved, the validation node may communicate a signal that the doors should be unlocked. If the user is not acceptable or not approved, the validation node may not communicate a signal that the door should be unlocked. Accordingly, the validation node may have information regarding who is entering a building. The feed engine may use this knowledge of the user entering the building to display content that is relevant to the user.

In another embodiment, the method may receive signals from audience members that provide an indication of the identity of audience members. For example, some cellular telephone may be set up to emit signals via Bluetooth technology, for example, that may be used to indicate the identity of the audience members. In another embodiment, radio frequency (“RF”) signals are used to provide an indication of the identity of audience members. This identity information may be used by the feed engine to display content that is relevant to the audience members.

At an even lower level, advanced technology may be used to determine the audience that will being viewing the display. For example, facial recognition software may be used to identify audience members as they walk into a building. Fingerprint technology and retina scan technology may also be used to identify audience members. Any technology that may be used to recognize people may be used to assist the feed engine locate and display relevant content.

The feed engine also may have the responsibility to display relevant content. I general, the feed engine attempt to display content it believes will be relevant to an audience member or may members of the audience. It may use a variety of tools to identify relevant content. In one embodiment, the engine may use keywords to identify relevant content. For example, if a building is a bank, stories that have the keyword “bank” (or other bank related keywords) may be selected to be displayed as these stories would be relevant to someone that worked in a bank

The feed engine also may attempt to prioritize content such that the content that is most relevant will be displayed to the proper audience. Again referring to the bank example, stories about bank interest rates would be more relevant than stories about blood banks, even though both use the term “bank.” The feed engine may prioritize the retrieved content to display the most relevant content to the proper audience.

The feed engine may rank the relevance of search terms to the audience. Referring to the bank example, a mortgage loan officer would be interested in stories about mortgage interest rates while a business loan officer would be more interested in stories about general economic conditions. While both loan officers work at a bank, the feed engine may recognize that certain terms will be more relevant to similar members of the audience.

The feed engine may also use parameterization to better locate relevant information for an audience member. Parameterization may be similar to determining keywords that are relevant to an audience member. If the feed engine does not have any content related to the keywords or concepts, then the feed engine may request such content or may search for such content.

In another embodiment, the feed engine may also be able to further monitor members of the audience in order to determine what would be relevant those audience members. Ignoring privacy concerns (perhaps a user authorizes monitoring), the feed engine may monitor an audience member's daily computer activity and may uses the activity to determine relevant content. For example, if a user spent the morning researching information on Microsoft Corporation, information about Microsoft may be relevant to that user and may be displayed to the user.

The feed engine also may have some logic to help determine the most relevant content to display to a large audience. As it may not be practical to display content to every person in an office building, some logic may help determine what content would be most relevant to the largest part of the audience. As a result, the content may not be as targeted as a search of the Internet on a specific keyword, but may be broader and more relevant to a larger portion of the audience.

As a result of the feed engine, the content displayed to audience members is not passive but is active in that the content changes based on the audience members. As a result, the content is more targeted to the audience, making the content more effective.

The content may also include advertisements on part of the display. The advertisements may be targeted to the audience. In addition, the characteristics that are used to select the content may also be used to sell the advertising space to advertisers. For example, if several members of an audience are known to be in the market for a new car, advertisers may be able to bid in an auction for the right to display advertisements related to new cars. The auction may be held at a prior time or in real time.

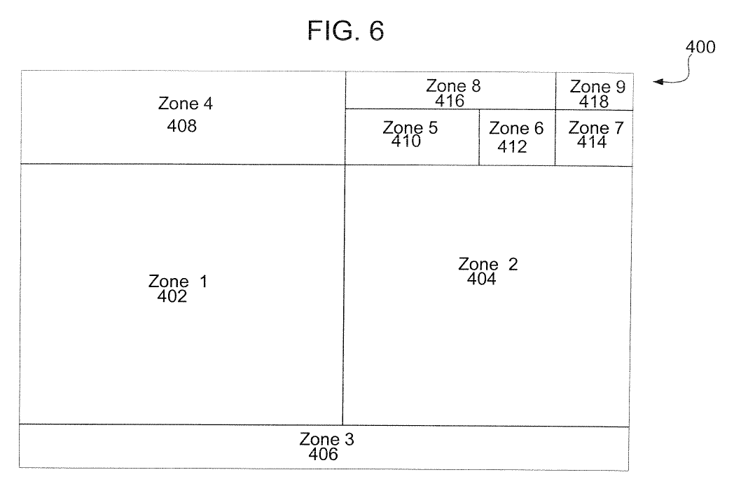

Subsequently, at a block 3 1 0 the network center 202 may communicate the data files to the display devices. In an embodiment, the data files may be communicated to the display devices using the file transfer protocol (FTP) method. However, alternate means of communications may also be used. Subsequently, at a block 312, the display devices may display the content from the data files on the screens. The displaying of information on the screen is described in further detail below with respect to FIGS. 6-7.

As one of ordinary skill in the art would appreciate, not all the blocks of the display program 300 need to be performed for a given implementation of the advertising system 200. As some blocks of the display program 300 may be used primarily to increase the efficiency of the display program 300, one or more such blocks may be omitted in a given implementation without affecting the functionality of the advertising system 200. Moreover, one or more of the blocks in the display program 300 may also be implemented in an alternate order without affecting the functionality of the advertising system 200.

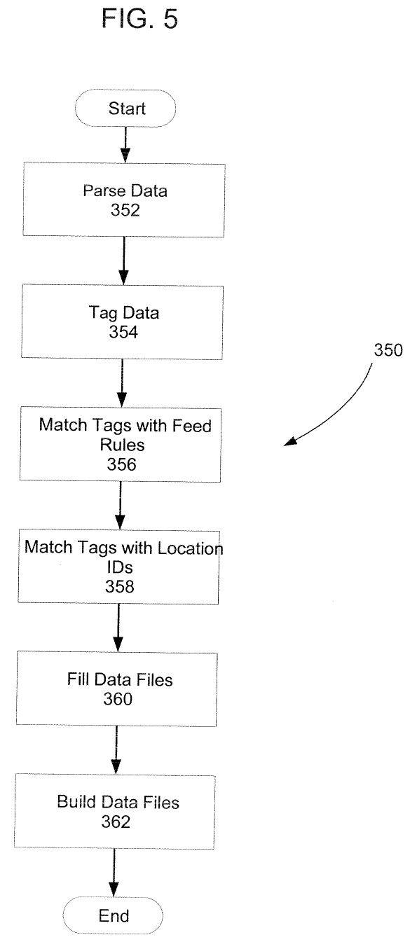

FIG. 5 illustrates an example flowchart of a data processing program 350 that may be used by the information display program of FIG. 4 to process information at the block 308. A block 352 parses data received from the information sources 204-208 into a number of different key data. For example, the block 352 may parse an XML file send by an information source into weather data, financial data, advertising data, scroll data, etc. Subsequently, a block 354 tags various data based with a plurality of keys to get key data. For example, block 354 may tag a part of the received data as headline key data, another part of the received data as summary data, etc. Alternatively, parsed data may be tagged by key words, section of the data feed, etc.

Subsequently, a block 356 selects tagged data based on various feed rules. For example, a rule may be to select a certain type of tagged data to be transmitted to certain display device on a certain day of the week, etc. Another example of selecting tagged data based on feel rule may be select data tagged as traffic information to be transmitted to display devices at certain times of the day. Subsequently, a block 358 matches various tags with various location identifications. For example, block 358 may use a feed rule to match data tagged as downtown law firm news data with identifications of display devices located in downtown law firms, etc.

Subsequently, block 360 creates data file to be sent to display devices with the data tagged by block 358. Thus, for example, there may be nine different types of tagged data, to be shown on nine different sections of a display device, into a data file that is to be sent to particular display device. The data file may be sent wirelessly or using a wire. The data file may be encrypted including using a key exchange/verification method. In an alternate embodiment, where a user may have provided a sound file providing directions in case of an emergency, such a sound file may also be attached to the data file. As shown in FIG. 4, subsequently, block 310 communicates such a data file to an appropriate display device.

Now referring to FIG. 6, an example screen shot 400 illustrates content displayed on various sections of a display device used by the advertising system 200. The image of FIG. 6 is divided into various zones 1-9. Different zones may be used to display different type of information from the data file communicated from the network center 202. For example zone 1 402 may be used to display licensed content from an information server or an advertisement, zone 2 404 may also be used to display licensed content from an information server or an advertisement, zone 3 406 may be used to display a scrolling news headline, zone 4 408 may be used to display a particular logo, zone 5 410 may be used to display a market index update, zone 6 412 may be used to display local weather, zone 7 414 may be used to display a building logo where the display is located, zone 8 416 may be used to display a day and date, zone nine 418 may be used to display local time, etc.

In an alternate embodiment, different zones may be used to display different set of information. For example, in an alternate embodiment, the entire screen of a display device may be used to display a fill screen advertisement, an emergency notification, etc.

In an alternate embodiment of the advertising system 200, some of the display devices 210-216 may have display screens equipped with touch input capability and such display devices may be located at a level close to the ground so that a user can provide an input to the screen. In such an implementation, a section on the display screen may display a menu that may be used by a user to provide an input. For example, the advertisement section 360 may display an advertisement and then invite users to input their contact information for getting more information regarding an advertised product, whereupon, such information may be communicated back to the network center 202.

Although the forgoing text sets forth a detailed description of numerous different embodiments of the invention, it should be understood that the scope of the invention is defined by the words of the claims set forth at the end of this patent. The detailed description is to be construed as example only and does not describe every possible embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

What is claimed is:

1. A method of displaying information on a display device, wherein the display device is communicatively connected to a network via a controller, the network having a plurality of information sources, the method comprising:
obtaining content from each of the plurality of information source;
automatically processing the content using a feed engine based on predetermined criteria;
communicating the processed content to the controller; and
displaying the content on the display device based on a rule set stored on the controller.

2. The method of claim 1, further comprising requesting content from each of the plurality of information source and retrieving content from each of the plurality of information sources.

3. The method of claim 1, wherein displaying the content on the display device further comprises displaying content from a first information source on a first section of the display and displaying content from a second information source on a second section of the display.

4. The method of claim 3, wherein displaying the content on the display device further comprises displaying an advertisement on the third section of the display.

5. The method of claim 2, wherein receiving content from each of the plurality of information sources comprises receiving content in the form of extensible markup language (XML) files.

6. The method of claim 5, wherein processing the content further comprises parsing the XML content files and generating network data files.

7. The method of claim 6, wherein the network data files include at least one of: (1) a news data file, (2) a market information data file; (3) a weather information data file; (4) a scroller data file; and (5) a traffic information data file.

8. The method of claim 7, wherein communicating the processed content to the controller further comprises communicating at least one of the data file to the controller using file transfer protocol (FTP).

9. The method of claim 1, further comprising allowing a user of the controller to change the predetermined criteria using a first website.

10. The method of claim 9, further comprising allowing a user of the controller to input a first message using the first website and displaying the first message on a fourth section of the display device.

11. The method of claim 10, further comprising allowing a user of the controller to overwrite the content displayed on the display device with a message to be displayed on the display device.

12. The method of claim 1, further comprising receiving an input from a user at the display device and communicating the user input to at least one of the plurality of information sources.

13. The method of claim 1, wherein each of the plurality of information sources is a web-server providing information to one of a plurality of websites.

14. The method of claim 2, wherein requesting content from each of the plurality of information sources further comprises:
receiving an information request from a user of the controller;
generating a request for content based on the information request from the user of the controller; and
communicating the request for content to each of the plurality of information sources.

15. The method of claim 1, wherein displaying the content on the display device further comprises displaying the content on the display device located in at least one of: (1) a lobby of an office complex; (2) a public transportation hub; (3) a coffee house; and (4) a restaurant.

16. A system for displaying information from a plurality of information sources on a display device, the system comprising:
a network center communicatively connected to each of the plurality of information sources, the network center adapted to communicate requests for content to each of the plurality of information sources;
the plurality of information sources adapted to communicate information content to the network center in response to the requests from the network center;
a memory communicatively connected to the processor to store a set of predetermined criteria, wherein the predetermined criteria is used by the network center in at least one of: (1) generating the requests for content to be sent to the information sources; (2) processing the information content received from the information sources; and (3) generating a plurality of data files to be sent to a plurality of controllers;
the plurality of controllers communicatively connected to the network center to receive data files, wherein each of the plurality of controllers are connected at one of a plurality of display devices; and
each of the plurality of display devices adapted to display the content of the data files received at its corresponding controller on a section of the display device.

17. The system of claim 16, further comprising allowing access to a controller using a website and using the website to change the content of the data files.

18. The system of claim 16, further comprising allowing access to network center to modify the predetermined criteria.

19. The system of claim 16, further comprising using wireless signals to communicate with the display devices.

20. The system of claim 16, further comprising using an encrypted message to communicate with the display devices.
